(19) United States
(12) Patent Application Publication
(10) Pub. No.: US 2014/0106241 A1
(43) Pub. Date: Apr. 17, 2014

(54) ELECTROCHEMICAL CELL WITH A ZINC-INDIUM ELECTRODE

(71) Applicant: VARTA Microbattery GmbH, Ellwangen (DE)

(72) Inventors: Cornelia Csrenko, Aalen (DE); Ulrich Kohls, Aalen (DE); Bernd Kreidler, Ellwangen (DE); Hermann Löffelmann, Ellwangen (DE); Andreas Rupp, Spraitbach (DE)

(73) Assignee: VARTA Microbattery GmbH, Ellwangen (DE)

(21) Appl. No.: 14/053,963

(22) Filed: Oct. 15, 2013

(30) Foreign Application Priority Data
Oct. 15, 2012 (EP) 12188541.2

(51) Int. Cl. H01M 4/42; H01M 4/62

(52) U.S. Cl. CPC H01M 4/42; H01M 4/624
USPC 429/406; 429/224; 429/219; 429/230; 252/512; 75/255; 75/351

(57) ABSTRACT

An electrochemical cell has an electrode which includes a zinc-indium alloy as electrochemically active material, wherein the alloy is present in the form of particles and the entirety of the particles is composed of at least two particle fractions differing in indium concentration.

### TECHNICAL FIELD

This disclosure relates to an electrochemical cell having an electrode which includes a zinc-indium alloy as electrochemically active material.

### BACKGROUND

Alkaline cells typically include zinc electrodes. Examples thereof are cells of the zinc-manganese oxide type, in particular alkaline manganese cells, zinc-air cells, zinc-silver oxide cells, and zinc-mercury oxide cells. All of these cells have a cell housing, wherein a zinc anode impregnated by an alkaline electrolyte is disposed. In general, the zinc is present in the form of particles.

As is well-known, zinc is thermodynamically instable in an alkaline environment. Thus, zinc electrodes of alkaline cells are in many cases subject to corrosion processes, wherein hydrogen evolution occurs. As a result of such hydrogen evolution, a severe pressure increase can occur in the interior of the cell housing. As a consequence thereof, electrolyte will leak from the cell housing through weak spots. Thereby, the life cycle of alkaline cells is likely to be considerably reduced.

Using amalgamation of the zinc powder, gas evolution in the cells can be prevented to a large extent. However, the addition of mercury is no longer acceptable in most of the countries in the world due to the severe toxicity of mercury. Accordingly, there is need for technical alternatives to amalgamation.

A well-known alternative to amalgamation is the addition of indium which can be alloyed to the zinc. Indium is effective in increasing the hydrogen overpotential in an alkaline environment and thus contributes to reduced corrosion.

There is thus a need to provide improved zinc electrodes for alkaline cells.

### SUMMARY

We provide an electrochemical cell including an electrode which includes a zinc-indium alloy as electrochemically active material, wherein the alloy is present in the form of particles and the entirety of the particles is composed of at least two particle fractions differing in indium concentration.

We also provide a method of producing an electrode including a particulate zinc-indium alloy for electrochemically active material including adjusting an indium concentration in anode zinc particles having a first concentration of indium by admixing to zinc particles having a second concentration of indium differing from the first concentration.

### BRIEF DESCRIPTION OF THE DRAWINGS

FIGS. 1-2 are graphs of voltage over time for Reference Cell A under different types of discharge.

FIG. 3 is a graph of resistance over time for Reference Cell A under different types of discharge.

FIG. 4-5 are graphs of voltage over time for Reference Cell C under different types of discharge.

FIG. 6 is a graph of resistance over time for Reference Cell C under different types of discharge.

### DETAILED DESCRIPTION

Our electrochemical cells comprise at least one electrode, in particular at least one anode, which includes a zinc-indium alloy as electrochemically active material. The alloy is present in the form of particles.

In particular, the cell is characterized in that the entirety of the particles comprises at least two particle fractions differing in regard to the indium concentration therein. While within one and the same fraction all particles have the same indium concentration, the particles differ in indium concentration from one fraction to another fraction. In other words, the cells preferably comprise a mixture comprising a first particulate zinc-indium alloy including a first concentration of indium (a first particle fraction) and at least one further particulate zinc-indium alloy including a second concentration of indium which is different from the first concentration of indium (a second particle fraction).

Surprisingly, we found that the use of a mixture of zinc alloys differing in regard to the indium concentration may result in a considerable increase in capacitance values of zinc electrodes, as compared to zinc electrodes in which only one type of zinc alloy is included.

Preferably, the entirety of the particles is composed of exactly two fractions, that is, of the first fraction and the second fraction. However, it is possible to employ mixtures of three or more fractions.

Preferably, the total proportion of indium in the cell is, in relation to the total amount of zinc in the cell, 50 ppm to 10000 ppm, preferably 50 ppm to 5000 ppm, particularly preferred 100 ppm to 2500 ppm, in particular 300 ppm to 2000 ppm. In other words, it is preferred that if all of the particles in the cell were homogenized by melting an alloy with an indium concentration within one of these ranges would be obtained.

Particularly preferred is that the entirety of the particles comprises a first particle fraction composed of particles including an indium concentration of up to 2500 ppm, preferably up to 1000 ppm, particularly preferred up to 500 ppm, and a second particle fraction composed of particles including an indium concentration of up to 10000 ppm, preferably up to 5000 ppm, particularly preferred up to 2500 ppm, wherein the indium concentration in the second particle fraction is higher than in the first fraction. It is preferred that the lower limit of the indium concentration of the particles of the first fraction is 25 ppm, particularly preferred 100 ppm. Further, is preferred that the lower limit of the indium concentration of the particles of the second fraction is 100 ppm, particularly preferred 250 ppm

Another option is (although not preferred) that a fraction is composed of zinc particles including 0 ppm indium and another fraction is composed of a zinc-indium alloy. In this case, the entirety of particles is composed preferably of three or more fractions, wherein one fraction is composed of the zinc particles including 0 ppm indium and at least two fractions are composed of indium-containing zinc particles.

Preferably, the indium concentrations in the at least two particle fractions, in particular in the first and the second particle fraction, differ by at least the factor of 1.1. Particularly preferred, the factor is between 2 and 10, in particular between 5 and 10.

Particularly preferably the proportions may be:
1% to 99%, preferably 5% to 75%, in particular 10% to 50%, of the particles belong to the first particle fraction, and
1% to 99%, preferably 5% to 75%, in particular 10% to 50%, of the particles belong to the second particle fraction,
wherein the percentages add up to 100%, if the entirety of particles is composed of two particle fractions.

Preferably, the particles of the at least two particle fractions do not differ in size. However, the particle sizes are not specifically important. In general, the average particle size of the particles in the cell is 1 μm to 500 μm.

In addition to the electrochemically active material, the electrode of cells comprise at least one of the following constituents:
an electrolyte, in particular an alkaline electrolyte,
an electrode binder,
a conductivity enhancer.

In general, the electrolyte used is an aqueous solution of sodium hydroxide or potassium hydroxide. Examples of a suitable electrode binder used are sodium carboxymethyl cellulose or a polyacrylate. Appropriate conductivity enhancers are, for example, indium compounds, like indium oxide or indium hydroxide, and even carbon black or graphite, as the case may be.

For a cathode, the cell preferably includes a cathode made of a manganese oxide, an air cathode, a silver (I) oxide cathode, or a mercury oxide cathode. Accordingly, the cell is preferably of the zinc-manganese oxide type, in particular an alkaline manganese cell, a zinc-air cell, a zinc-silver oxide cell, or a zinc-mercury oxide cell. Furthermore, the cell can be a gas evolution cell, for example, having a structural design as described in DE 35 32 335 A1.

In particular, when the cell is a zinc-air cell, indium oxide and/or indium hydroxide are used to enhance conductivity.

The electrochemical element is particularly preferred to be a button cell. Such a button cell of an electrochemical element preferably has a metallic housing composed of two component halves, namely a cell cup and a cell lid. Particularly appropriate are cell cups and cell lids made of nickel-plated steel or made of a so-called “trimetal” (a clad metal composed of three metal layers). Suitable trimetals are in particular steel sheets with a coating made of copper on one side and a coating made of nickel on the other side.

Our methods for production of an electrode for the cell as described include a particulate zinc-indium alloy as electrochemically active material. To adjust the indium concentration in the anode, zinc particles having a first concentration of indium are admixed to zinc particles having a second concentration of indium which is different from the first concentration. The zinc particles of the first concentration of indium make up the above described first particle fraction in the electrode, the zinc particles of the second concentration of indium make up the second particle fraction in the electrode.

The above and further advantages will become apparent from the following description of representative examples in connection with the drawings. Therein, individual features may be realized on their own or in combination with one or more thereof. The described examples serve merely for illustration and better understanding and are in no way to be interpreted as limiting.

### EXAMPLES

### (1) Production of a Reference Cell A (Zinc/Air System)

To produce a zinc electrode, a particulate zinc-indium alloy having a concentration of indium of 300 ppm and an average particle size of ca. 150 μm was admixed to indium hydroxide as a conductivity enhancing agent and polyacrylic acid as a binder. The proportions of conductivity additive and binder in the mixture were 0.1% by weight (conductivity additive) and 0.3% by weight (binder), respectively. The proportion of zinc was correspondingly 99.6% by weight.

The three constituents were agitated extensively. Subsequently, the obtained powder was trickled into the cell lid of a button cell housing and an alkaline electrolyte was added. The cell lid was combined with an appropriate sealing, and then inserted into a matching cell cup including an air-oxygen electrode and a separator. Finally, the housing composed of the two halves was closed by a flanging procedure.

### (2) Production of a Reference Cell B (Zinc/Air System)

In a procedure analogous to (1), another reference cell was produced with one exception: instead of the particulate zinc-indium alloy having a concentration of indium of 300 ppm a zinc-indium alloy having a concentration of indium of 2000 ppm was used.

### (3) Production of an Example of Our Cells, Cell C (Zinc/Air System)

Our cells were produced the same as (1) and (2), with one exception: instead of the particulate zinc-indium alloys having a concentration of indium of 300 ppm and 2000 ppm an admixture of the two alloys as used in (1) and (2) was used in a proportion of 3.3:1 (300 ppm: 2000 ppm).

(4) For a comparison of the capacitance levels of our cells to the reference cells, the cells produced according to (1) to (3) were subjected to discharge monitoring (IECH, IECL, pulsed resistance discharge). The results are given below:

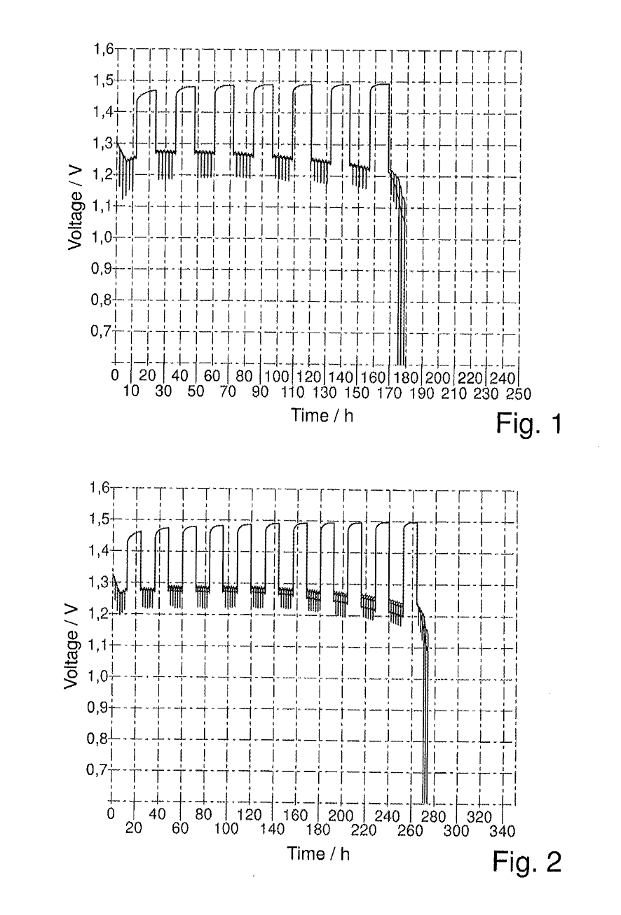

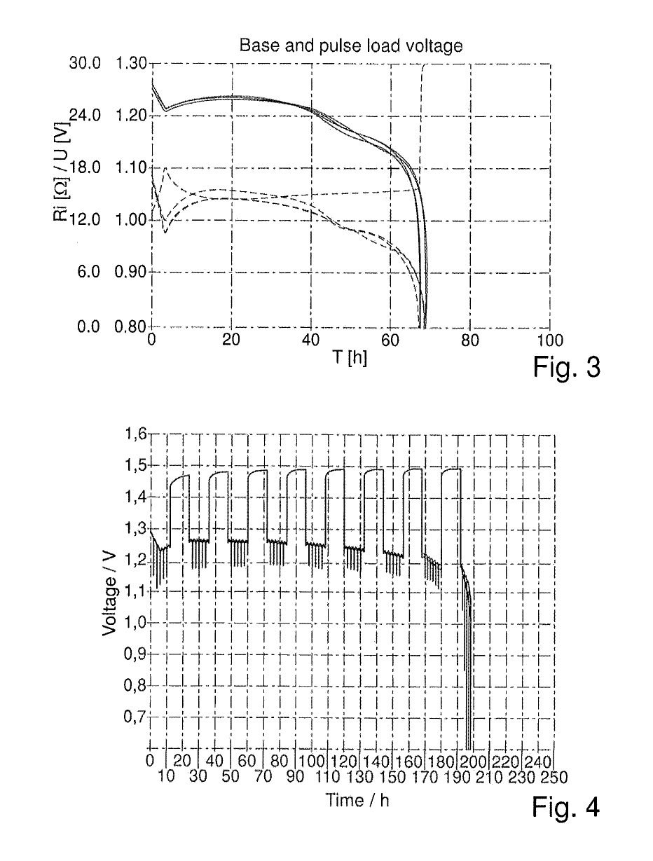

Reference cell A

| Type of discharge | Capacitance | Zinc utilization | Note |
|---|---|---|---|
| IECH | 280 mAh | 90% | cf. FIG. 1 |
| IECL | 282 mAh | 91% | cf. FIG. 2 |
| Resistance discharge | 270 mAh | 87% | cf. FIG. 3 |

Reference cell B

| Type of discharge | Capacitance | Zinc utilization |
|---|---|---|
| IECH | 279 mAh | 90% |
| Resistance discharge | 257 mAh | 83% |

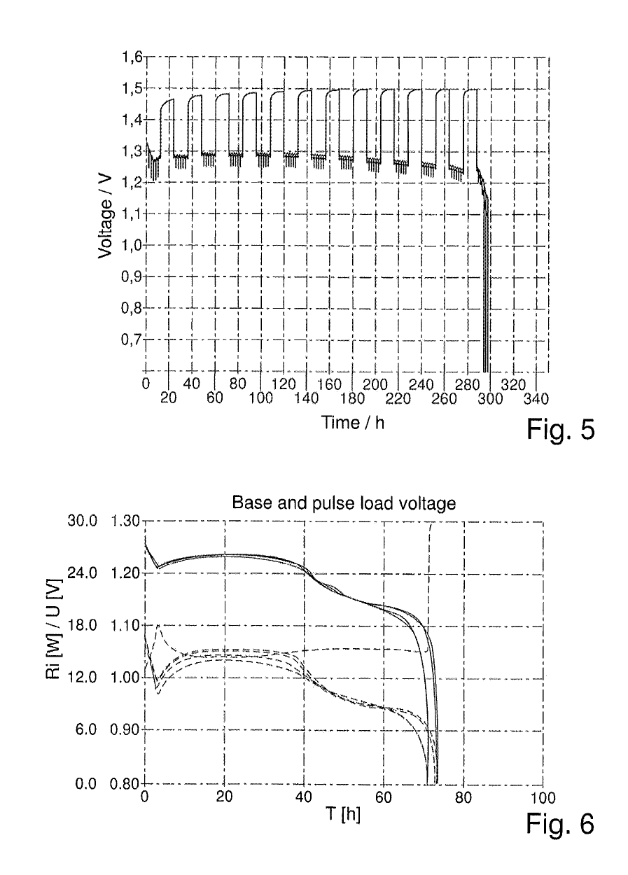

Our Cell C

| Type of discharge | Capacitance | Zinc utilization | Note |
|---|---|---|---|
| IECH | 297 mAh | 96% | cf. FIG. 4 |
| IECL | 302 mAh | 98% | cf. FIG. 5 |
| Resistance discharge | 285 mAh | 92% | cf. FIG. 6 |

1. An electrochemical cell comprising an electrode which includes a zinc-indium alloy as electrochemically active material, wherein the alloy is present in the form of particles and the entirety of the particles is composed of at least two particle fractions differing in indium concentration.

2. The cell according to claim 1, wherein the total proportion of indium in the cell is, in relation to the total amount of zinc in the cell, 50 ppm to 5000 ppm.

3. The cell according to claim 1, wherein the entirety of the particles comprises a first particle fraction composed of particles including an indium concentration of up to 2500 ppm, and a second particle fraction composed of particles including an indium concentration of up to 10000 ppm, wherein the indium concentration in the second particle fraction is higher than in the first fraction.

4. The cell according to claim 1, wherein the indium concentration in the at least two particle fractions differ by at least the factor of 1.1.

5. The cell according to claim 3, where
1% to 99% of the particles belong to the first particle fraction,
1% to 99% of the particles belong to the second particle fraction,
the percentages add up to 100%, if the entirety of particles is composed of two particle fractions.

6. The cell according to claim 1, wherein the particles of the at least two particle fractions do not differ substantially in size.

7. The cell according to claim 1, wherein the electrode further comprises at least one selected from the group consisting of an electrolyte, in particular an alkaline electrolyte, an electrode binder and a conductivity enhancing means.

8. The cell according to claim 1, further comprising a cathode made of a manganese oxide cathode, an air cathode, a silver (I) oxide cathode, or a mercury oxide cathode.

9. A method of producing an electrode including a particulate zinc-indium alloy for electrochemically active material comprising adjusting an indium concentration in anode zinc particles having a first concentration of indium by admixing to zinc particles having a second concentration of indium differing from the first concentration.

10. The cell according to claim 2, wherein the entirety of the particles comprises a first particle fraction composed of particles including an indium concentration of up to 2500 ppm, and a second particle fraction composed of particles including an indium concentration of up to 10000 ppm, wherein the indium concentration in the second particle fraction is higher than in the first fraction.

11. The cell according to claim 2, wherein the indium concentration in the at least two particle fractions differ by at least the factor of 1.1.

12. The cell according to claim 3, wherein the indium concentration in the at least two particle fractions differ by at least the factor of 1.1.

13. The cell according to claim 4, where
1% to 99% of the particles belong to the first particle fraction,
1% to 99% of the particles belong to the second particle fraction,
the percentages add up to 100%, if the entirety of particles is composed of two particle fractions.

14. The cell according to claim 3, wherein 10 to 50% of the particles belong to the first fraction.

15. The cell according to claim 3, wherein 10 to 50% of the particles belong to the second fraction.

16. The cell according to claim 4, wherein the factor is 5 to 10.
